(19) United States
(12) Patent Application Publication
(10) Pub. No.: US 2026/0265582 A1
(43) Pub. Date: Sep. 10, 2026

(54) FILM FOR FORMING A BOARD MATERIAL, AND BOARD MATERIAL

(71) Applicant: Profol GmbH, Halfing (DE)

(72) Inventor: Maximilian Prassberger, Halfing (DE)

(21) Appl. No.: 19/165,516

(22) PCT Filed: Aug. 16, 2024
(86) PCT No.: PCT/EP2024/073080

§ 371 Date: Sep. 15, 2025

(30) Foreign Application Priority Data
Aug. 16, 2023 (EP) 23191633.9

(51) Int. Cl. C09J 7/29; C09J 7/38

(52) U.S. Cl. CPC C09J 7/29; C09J 7/381; C09J 2301/162; C09J 2301/414; C09J 2423/006; C09J 2423/106; C09J 2451/00

(57) ABSTRACT

A film for forming a board material by applying the film to a substrate, said film including a decor layer group containing a bonding layer that is bonded to the substrate to form the board material, a decor base layer on the bonding layer, a decor carrier layer on the decor base layer, and a decor layer on the decor carrier layer; a wear protection group on the decor layer of the decor layer group, containing a further bonding layer on the decor layer, a transparent base layer on the further bonding layer, and an embossed surface layer on the transparent base layer; as well as a lacquer layer on the embossed surface layer of the wear protection group.

### TECHNICAL FIELD

The present invention relates to a film for forming a board material by applying the film to a substrate, in particular made of a material that is stiff as compared to the film. The invention furthermore relates to such a board material, in particular a floor element.

### TECHNOLOGICAL BACKGROUND

Board materials are widely used as building, furnishing, decorative and construction materials. Such board materials are often provided in the form of so-called laminates, in which a laminate layer covers a substrate. The laminate layer provides the desired appearance and surface properties, while the substrate provides the mechanical stability. This allows the surface requirements to be separated from the mechanical requirements, thus resulting in a number of advantages in terms of efficiency, cost, weight, etc.

The requirements placed on the surface of such a board material include not only optical requirements in terms of an optical and visual impression to be achieved, but also haptic properties and, in particular, abrasion resistance and durability. The first properties mentioned should include not only tactilely discernible properties, but also the properties of the surface structure in general. The latter properties overall relate to the abrasion caused through usage of the board material, for example also the abrasion caused by use of the board material, in particular in the form of or as part of a floor.

It is not always possible to achieve all the above objectives together to a satisfactory extent. In particular the provision of high-quality patterns with satisfactory durability and acceptable manufacturing costs is often a challenge. It is therefore an object of the present invention to provide a film for forming a board material by applying the film to a substrate, which combines high-quality decor with high abrasion resistance and cost-efficient production. It is a further object of the present invention to provide a corresponding board material, in particular in the form of a floor element.

### SUMMARY

The aforementioned objects are solved by means of a film for forming a board material by applying the film to a substrate according to patent claim 1 and a board material according to patent claim 16. Further advantageous embodiments of the present invention are specified in the dependent patent claims.

A film for forming a board material by applying the film to a substrate is accordingly provided, said film comprising a decor layer group comprising a bonding layer that is bonded to the substrate to form the board material, a decor base layer on the bonding layer, a decor carrier layer on the decor base layer, and a decor layer on the decor carrier layer; a wear protection group on the decor layer of the decor layer group, comprising a further bonding layer on the decor layer, a transparent base layer on the further bonding layer, and an embossed surface layer on the transparent base layer; as well as a lacquer layer on the embossed surface layer of the wear protection group.

A board material is furthermore provided, comprising a film according to one of the embodiments described herein and a substrate made of a material having a greater stiffness than the film.

### BRIEF DESCRIPTION OF THE DRAWINGS

Embodiments of the present inventions will now be described in more detail with reference to the following figures. The corresponding description merely serves to provide a better understanding of the teaching according to the invention and the advantages associated therewith, but should not be understood as limiting at any point. The figures show the following:

FIG. 1 schematically shows the basic structure of a film according to an embodiment of the present invention; and

FIGS. 2A & 2B schematically show the basic structure of a board material having a film according to an embodiment of the present invention.

### DETAILED DESCRIPTION

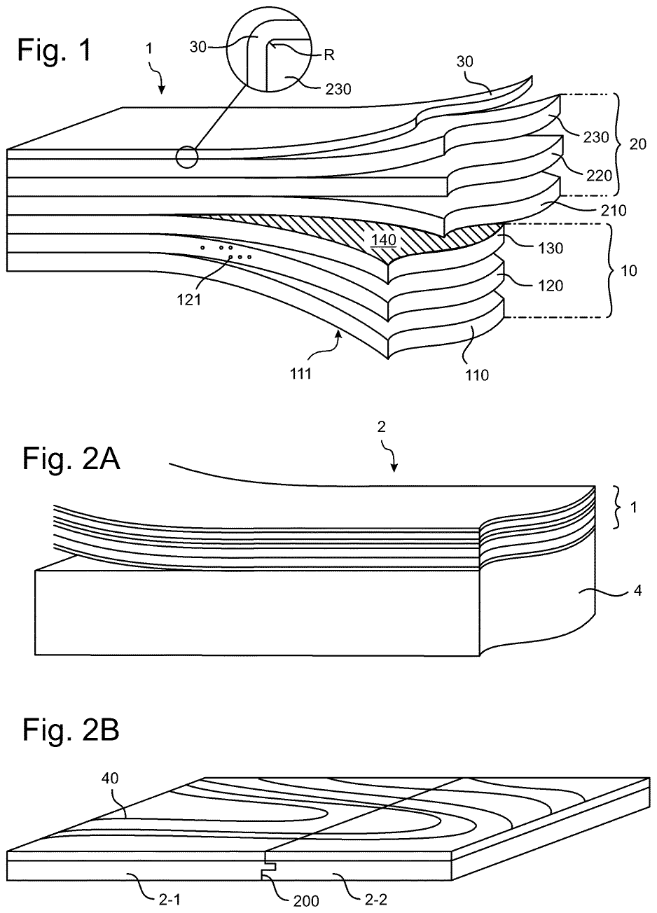

FIG. 1 schematically shows the basic structure of a film according to an embodiment of the present invention, in particular a film 1 for forming a board material by applying the film to a substrate. The film 1 comprises a decor layer group 10, which in turn comprises a bonding layer 110, a decor base layer 120 and a decor layer 130. The bonding layer 110 is bonded to a substrate to form a board material and may comprise, in part, preferably in full, a polypropylene (PP) block copolymer, random copolymer, terpolymer or elastomer.

The outer surface 111 of the bonding layer 110 of the decor layer group 10 may be polarised, radicalised and/or corona-pretreated. With the right choice of polymer for the bonding layer 110, good durability of the pre-treatment and good wettability with a primer or adhesive system that may be used later can thus be achieved. The bonding layer 110 generally provides good adhesivity and/or good thermal laminability. The last-mentioned lamination usually involves melting the contact surface onto a hot substrate, for example a polypropylene (PP) board, in order to thus achieve thermal fusion of the two contact surfaces.

Used as the starting materials for bonding layer 110 are preferably PP block copolymers, random copolymer, terpolymer or elastomer for good durability of the corona pre-treatment and good wettability with a primer as well as good adhesivity in general, PP homopolymer as well as blends of the cited PP polymer types for the desired stiffness and material stability in general, one or more UV stabilisers so as to be equipped at least against UV exposure indoors and to prevent yellowing and embrittlement, and/or an anti-block additive to prevent blocking during winding, storage and processing of the film 1.

The decor base layer 120 of the decor layer group 10 is disposed on the bonding layer 110. The decor base layer 120 may comprise, at least in part, a polyolefin-based plastic, preferably polypropylene. The decor base layer 120 may also comprise a colouring component 121. A polypropylene mixture consisting of block copolymer for toughness and homopolymer and fillers such as talc and/or chalk for stiffness and thermal stability in the printing process may in particular be used as the starting material. Additives such as UV stabilisers with a colour component such as titanium dioxide may also be used. In general, this layer should provide both good calenderability (for example by mechanically smoothing the film for optimum printability in the film manufacturing process) and satisfactory mechanical strength during printing, including sufficient resistance in relation to thermal stress during drying of the printing inks and web tension.

The decor layer group 10 furthermore comprises a decor carrier layer 130 on the decor base layer 120. The decor carrier layer 130 may comprise at least in part, preferably in full, a block copolymer and/or a PP homopolymer as well as one or more UV stabilisers. In general, a good calenderability, a smooth surface and good printability should be provided. A block copolymer can be used as the starting material for good durability of the corona pre-treatment and thus good wettability during printing. Good embossability, calendering and smoothing of the surface for printability can also be achieved in this manner. PP homopolymers may furthermore be used for the desired stiffness and material stability in general, and/or one or more UV stabilisers so as to be equipped at least against UV exposure indoors and to prevent yellowing and embrittlement, and/or an anti-block additive to prevent blocking during winding, storage and processing of the film 1.

The decor layer group 10 furthermore comprises a decor layer 140 on the decor carrier layer 130. The decor layer 140 does not have to be present as a continuous layer, but rather merely designates a decor on the decor carrier layer 130 in the form of a decor or print, i.e. a layer or an area in which a colour or colour pigments are arranged at least in part. The decor layer 140 may in particular consist of a printed area of the decor carrier layer 130. The decor layer 140 may comprise a colourant in a casein-, polyurethane-or acrylic-based binder, and may be formed as a water-based and/or organic-solvent-based colouring system in conventional printing processes such as gravure printing or digital printing.

In general, the decor layer group 10 described above can be produced as a component, which can also simplify the printability, i.e. the formation of the decor or decor layer, in particular during manufacture. Since in particular the sub-layers 110, 120 and 130 of the decor layer group 10 can each be extruded or cast layers, the manufacture thereof differs from the formation of the decor. Whereas the sub-layers 110, 120 and 130 of the decor layer group 10 are usually manufactured in a coextrusion roll stand, printing can be carried out using other devices specifically optimised for printing. The structure of the film 1 according to the invention thus makes it possible to produce the decor layer group 10, then print it in a separate device to form the decor layer 140, and subsequently bond it to the other components of the film.

The film 1 furthermore comprises a wear protection group 20 on the decor layer 140 of the decor layer group 10. The wear protection group 20 comprises a further bonding layer 210 on the decor layer 140, a transparent base layer 220 on the further bonding layer 210, and an embossed surface layer 230 on the transparent base layer 220. In general, however, the embossing can be present not only in the layer 230, but also in the transparent base layer 220 and other layers.

The further bonding layer 210 of the wear protection group 20 may comprise a thermoplastic elastomer, a polyolefin-based plastic, polypropylene and/or polyethylene. The further bonding layer 210 may furthermore comprise an adhesion promoter (HV), preferably maleic anhydride grafted polypropylene or polyethylene. In general, the bonding layer 210 can provide a bond between the wear protection group 20 and the printed decor layer group 10 with good adhesion, longevity, and temperature resistance. Maleic anhydride (MSA, MAH) grafted elastomers, polypropylene (PP) and/or polyethylene (PE) may, for example, be used as starting materials. In particular maleic anhydride can form a chemical bond with the binder of the printing ink as part of the decor layer 140 of the decor layer group 10 in order to achieve a permanent adhesion between the wear protection group 20 and the decor layer group 10. The surface energy of the bonding layer 210 can furthermore be increased, which also leads to physical adhesion.

Even though an elastomer can also provide a certain degree of adhesion by itself, the general rule is that the higher the amount of MAH, the better the adhesion. The carrier material, the way in which the MAH is grafted and how much MAH is “available” for the reaction are also decisive factors. MAH adhesion promoter can be mixed, as in the present case, if it is present as a concentrate, or it may also be used at 100%. Process parameters such as processing temperature and pressure in the roll gap in which the wear protection group 20 and decor layer group 10 are bonded, as well as subsequent conditioning at temperatures above room temperature also have an influence on the subsequent adhesion. The adhesion partner “printing ink” additionally has an influence on the adhesion. A PU binder is clearly superior to a casein binder here.

The wear protection group 20 furthermore comprises a transparent base layer 220 on the further bonding layer 210. The transparent base layer 220 of the wear protection group 20 is formed on the further bonding layer 210. The transparent base layer 220 may comprise, at least in part, preferably in full, a random copolymer. In general, this layer has a good embossability with various structures such as wood or stone patterns, good properties against abrasion as well as good transparency to the decor layer group 10. In particular, the decor image of the decor layer 140 is thus clearly visible, which is beneficial in particular to the visual impression of the film 1. The starting materials used here may be a PP random copolymer, a PP homopolymer, a block copolymer or mixtures thereof for good embossability and transparency, an elastomer to further increase the embossability, a combi-batch consisting of a UV stabiliser and a UV absorber to protect both the film 1 itself from yellowing and embrittlement and to protect the printed image under the film, i.e. essentially the decor layer 140 of the decor layer group 10, from UV radiation (UV absorber).

The wear protection group 20 furthermore comprises a surface layer 230 on the transparent base layer 220. The transparent base layer 220 may be softer than the surface layer 230 and may preferably comprise an elastomer. The transparent base layer 220 may also comprise an elastomer, and both layers 230 and 220 are embossed (together). The surface layer 230 may further comprise an embossing with varying structure and depth, the edges of which have a bend radius of at least 10 μm (see radius “R” in the inset of FIG. 1). A contour-accurate coating with a lacquer can thus take place in an advantageous manner. In general, good embossability with various structures such as wood or stone patterns, good lacquerability and high abrasion resistance can thus be achieved. The starting materials used here may be a block copolymer for good durability of a corona pre-treatment and thus good lacquerability as well as advantages when embossing the surface, an elastomer to improve embossing of the surface due to this soft raw material, one or more UV stabilisers so as to be equipped at least for UV exposure indoors and to prevent yellowing and embrittlement, as well as an antiblock to prevent blocking during winding.

The film 1 furthermore comprises a lacquer layer 30 on the embossed surface layer 230 of the wear protection group 20. The lacquer layer 30 preferably comprises one or more layers of excimer lacquer. Such a coating with a UV lacquer can provide scratch resistance, a matt appearance and resistance to chemicals. The lacquer layer 30 is preferably applied at an application amount of ≥10 g/m². The special excimer curing process for lacquer layer 30 causes folding of the lacquer surface before curing. This folding produces a particularly matt surface.

In general, the film 1 may furthermore comprise a primer layer on the bonding layer of the decor layer group. This primer may comprise a polyurethane (PU) dispersion with silicic acid to improve adhesivity with adhesive systems on various carrier substrates such as wood materials or linoleum. The application amount may be in a range of 2 to 10 g/m² in a dried state.

FIGS. 2A & 2B schematically show the basic structure of a board material with a film according to an embodiment of the present invention. Shown in general in FIG. 2A is a board material 2 comprising a film 1 according to one of the described embodiments and a substrate 4 made of a material having a greater stiffness than the film. The material strengths (thickness) of the film 1 and the substrate 4 only play a minor role, and the substrate is primarily intended to provide the stiffness (bending stiffness) of the board material 2. The materials used for the substrate 4 may be wood, plywood or multiplex wood, chipboard, particleboard, medium-density fibreboard, MDF, polypropylene (PP), polyethylene (PE), recyclate, and so on. The use of an optional primer on the bonding layer of the decor layer group of the film 1 can be tailored in particular to the surface properties of the substrate 4 as well as the adhesive system used. A stable, cost-effective, weight-efficient, abrasion-resistant, durable and visually appealing board material is advantageously obtained according to these embodiments of the present invention.

FIG. 2B shows a board material in the form of floor elements 2-1, 2-2 comprising a film 1 according to one of the described embodiments and a substrate 4 made of a material having a greater stiffness than the film. The properties and possibilities mentioned in connection with FIG. 2A apply. As a floor element, the board material 2-1, 2-2 is supposed to convey an appropriate visual impression 40, which is provided in particular by the decor layer 140 of the decor carrier layer 130 of the decor layer group 10 in conjunction with the embossing of the embossed surface layer 230 of the wear protection group 20 and the lacquer layer 30 on the embossed surface layer.

The properties of the transparent base layer 220, the optical properties of the further bonding layer 210 as well as the background effect of the decor base layer 120 and the decor carrier layer 130 of the decor layer group 10 also advantageously contribute to the overall visual impression 40. The colouring component 121 of the decor base layer 120 can furthermore contribute to the overall visual impression 40. The floor elements 2-1, 2-2 may furthermore comprise tongue and groove or other fastening elements 200, in particular to provide an entire floor covering with the board material according to an embodiment of the present invention. FIG. 2B thus shows an embodiment with a so-called click connection. However, a board material according to the invention may also be configured as a flexible roll material for gluing (without a click system).

The described embodiments are generally only intended to provide a better understanding of the present invention. However, this description is in particular not intended to limit the scope of protection, which is determined solely by the independent claims.

1. A film for forming a board material by applying the film to a substrate, the film comprising:
a decor layer group comprising a bonding layer that is bonded to the substrate to form the board material, a decor base layer on the bonding layer, a decor carrier layer on the decor base layer, and a decor layer on the decor carrier layer;
a wear protection group on the decor layer of the decor layer group, comprising a further bonding layer on the decor layer, a transparent base layer on the further bonding layer, and an embossed surface layer on the transparent base layer; and
a lacquer layer on the embossed surface layer of the wear protection group.

2. The film according to claim 1, further comprising:
a primer layer on the bonding layer of the decor layer group.

3. The film according to claim 1, wherein the transparent base layer of the wear protection group comprises an embossing.

4. The film according to claim 1, wherein the bonding layer of the decor layer group comprises, at least in part, a block copolymer, random copolymer, terpolymer or elastomer.

5. The film according to claim 4, wherein the outer surface of the bonding layer of the decor layer group is polarised, radicalised and/or corona pre-treated.

6. The film according to claim 1, wherein the decor base layer of the decor layer group comprises, at least in part, a polyolefin-based plastic.

7. The film according to claim 6, wherein the decor base layer comprises a coloring component.

8. The film according to claim 1, wherein the decor carrier layer of the decor layer group comprises, at least in part, a block copolymer and/or PP homopolymer.

9. The film according to claim 1, wherein the decor layer comprises a colourant in a casein-, polyurethane-or acrylic-based binder and the decor layer is applied as a water-based and/or organic-solvent-based colouring system in conventional printing processes such as gravure printing or digital printing.

10. The film according to claim 1, wherein the further bonding layer of the wear protection group comprises a thermoplastic elastomer, a polyolefin-based plastic, polypropylene and/or polyethylene.

11. The film according to claim 10, wherein the further bonding layer comprises an adhesion promoter.

12. The film according to claim 1, wherein the transparent base layer of the wear protection group comprises, at least in part, full, a random copolymer.

13. The film according to claim 1, wherein the base layer of the wear protection group is soft as compared to the surface layer.

14. The film according to claim 1, wherein the embossed surface layer of the wear protection group comprises an embossing, the edges of which have a bend radius of at least 10 μm.

15. The film according to claim 1, wherein the lacquer layer comprises one or more layers of an excimer lacquer.

16. A board material, comprising a film according to claim 1, and a substrate made of a material having a greater stiffness than the film.

17. The film according to claim 1, wherein the decor base layer of the decor layer group comprises, at least in part, a polypropylene.

18. The film according to claim 10, wherein the further bonding layer comprises a maleic anhydride grafted polypropylene.

19. The film according to claim 13, wherein the base layer comprises an elastomer.
